(19) United States
(12) Patent Application Publication
(10) Pub. No.: US 2005/0263060 A1
(43) Pub. Date: Dec. 1, 2005

(54) ANIMATED DEVICE FOR A VEHICLE

(76) Inventor: David J. Armstrong, Pullman, WA (US)

Correspondence Address: GREENBERG & LIEBERMAN, 314 PHILADELPHIA AVE., TAKOMA PARK, MD, 20912, US

(21) Appl. No.: 10/709,778

(22) Filed: May 27, 2004

(51) Int. Cl. B60Q 11/00

(52) U.S. Cl. 116/28 R

(57) ABSTRACT

A vehicle decoration having animated components. The decoration is placed on the radio antenna or on edge of a car window. As wind speed increases a rising member with fixed wings begins to rotate and travels up the antenna. Above the rising member is an indicia that travels up the antenna along with the rising member. The indicia can display and desired sports team, logo, pattern or phrase. When the wind speed decreases the rising member and indicia rotate back down the antenna.

### BACKGROUND OF INVENTION

The present invention is an animated device for a vehicle, more specifically it is an animated device for a vehicle with the means to fly and rotate around a pole.

Often a vehicle owner chooses to decorate their vehicle to personalize it. They may choose to add bumper stickers or antenna balls to state opinions, advertise their business, or to show support for a particular team. However, bumper stickers or antenna balls are stationary and do not necessarily attract others. It is desirable to have a vehicle decoration or personalization means that actually moves.

U.S. Pat. No. 5,055,326 issued to Whittington on Oct. 8, 1991 shows an automotive supported pompon. Whittington's invention is unlike the present invention because it extends the entire length of the vehicle antenna, it does not circulate around the antenna and it does not rise or fall on the length of the antenna with increase or decrease in air speed.

U.S. Patent Application Publication no. 2003/0017778 published by Gibbs on Jan. 23, 2003 shows an aerial plain (sic). Gibbs' invention is unlike the present invention as it is a plane shaped device that is attached by a ball or other means to the antenna. It does not provide a flyer to rise and fall along the antenna with an increase or a decrease in speed.

Therefore a need has been established for device that can be used to personalize and advertise. Such a device needs to be capable of moving so that others are attracted to it.

### SUMMARY OF INVENTION

The present invention is a flying antenna ball that attaches to an vehicle antenna, which can rise and fall depending on wind speed, and can be used to move a flag or banner up or down on the antenna.

The system includes a rising member, which has a hole through the center of the member. The user would place the rising member on the antenna by means of the hole through the center. The rising member has an attachment such as a flag or banner that can extend up to five inches from the rising member. The flag or banner can be of a patriotic or an advertising means. The rising member is attached to the antenna when the antenna is in a vertical position from the vehicle. If the vehicle has an antenna, which does not have a vertical rise, the invention will include a pole, which can be attached to the vehicle to provide a vertical rise. The system can be attached to any type of vehicle. The rising member can have the flag attached and rotate by means of the velocity produced by the movement of the vehicle.

For example, the rising member is placed on the antenna and when the vehicle is in a still or stopped position, the rising member will be at the resting place close to the vehicle body and at one end of the antenna, specifically the end closest to the vehicle.

When the vehicle begins to move in either a forward or reverse motion, the wind speed around the vehicle will increase. This wind speed will force the rising member from the bottom of the antenna to the top of the antenna. The rising member will rotate along the antenna axis until reaching the top of the antenna. There is a cap or stopping mechanism at the top of the antenna, to keep the rising member on the antenna.

As the rising member rises and rotates, the banner or flag also rotates or flies from the wind velocity, created by the speed of the vehicle. In alternate embodiments of the present invention the flag or banner can be placed above the rising member, so the flag will be pushed to the top of the antenna by means of the rising member.

### BRIEF DESCRIPTION OF DRAWINGS

FIG. 1 is a front view of the present invention at the rest position.

FIG. 2 is a front view of the present invention in wind speed conditions of 10-35 mph.

FIG. 3 is a front view of the present invention in wind speed conditions of above 35 mph.

FIG. 4 is a front view of the present invention's alternate embodiment at wind speed conditions of above 35 mph.

FIG. 5 is a top view of an alternative embodiment of the present inventions.

### DETAILED DESCRIPTION

The present invention is a decoration in the form of a rising member and an indicia attachable to vehicle antenna and or window that rotates and or slides, up or down, as a result of increase or decrease in wind speed created buy the motion of any vehicle, capable of at least five mph, possessing radio antenna or window.

The present invention has two main goals. First, the present invention takes vehicle decorations a step further by animating them; and second, the present invention allows people to further customize their vehicle.

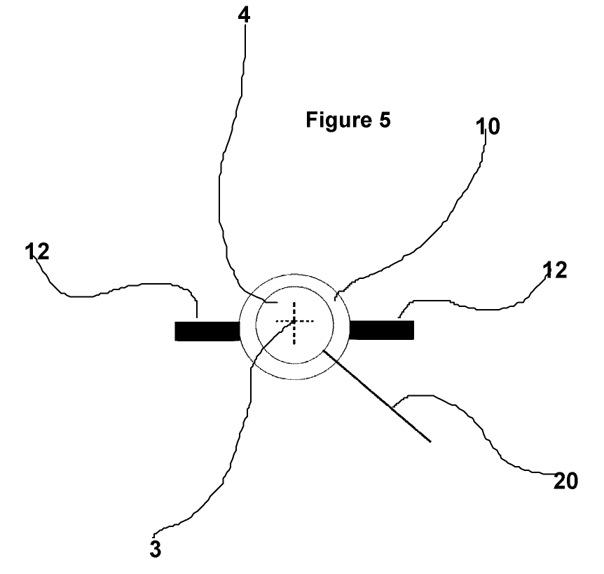

The present invention has a rising member (10) and indicia (20) both attached to antenna (1). In the preferred embodiment the rising member (10) would be a sphere. Rising member (10) has two fixed wings (12) and either two small apertures (14) or two larger apertures (15) (large apertures (15) shown only in FIG. 5). Indicia (20) has either a small sleeve (22) or a large sleeve (24) (small sleeve (24) shown only in FIG. 5) to allow the indicia (20) to attach and slide freely on antenna (1) and crossed pole (3) (crossed pole (3) shown only on FIG. 5). Indicia (20) can be any desired symbol, logo and or figure, to suit the taste of the consumer.

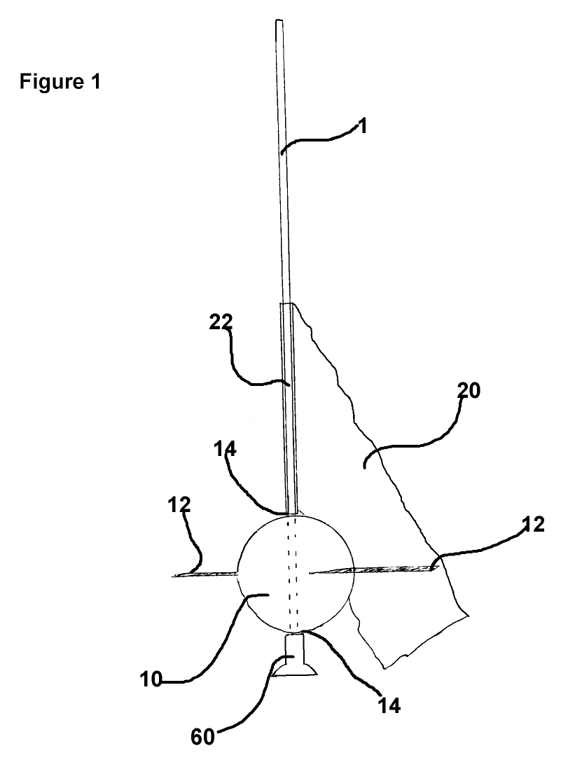

FIGS. 1-3 display the present invention in three different positions. FIG. 1 shows the present invention in the rested position at the base 60 of a vehicle antenna (1). The antenna (1) is inserted through the center of rising member (10) via small apertures (14) and then through small sleeve (22) in order to allow rotation up and down. Attached to rising member (10) are fixed wings (12) to induce the lift and rotation needed to achieve the main goal of the present invention. Fixed wings (12) are slanted such as a propeller would be to create the rotation effect. Small sleeve (22) is responsible for holding indicia (20) onto antenna (1).

FIG. 1 shows the present invention in the rested position. In order for the present invention to be in the rested position the rising member (10) must be sitting at the base of antenna (1). The present invention also requires that the vehicle is at a complete stand still and a wind speed of no more than five mph.

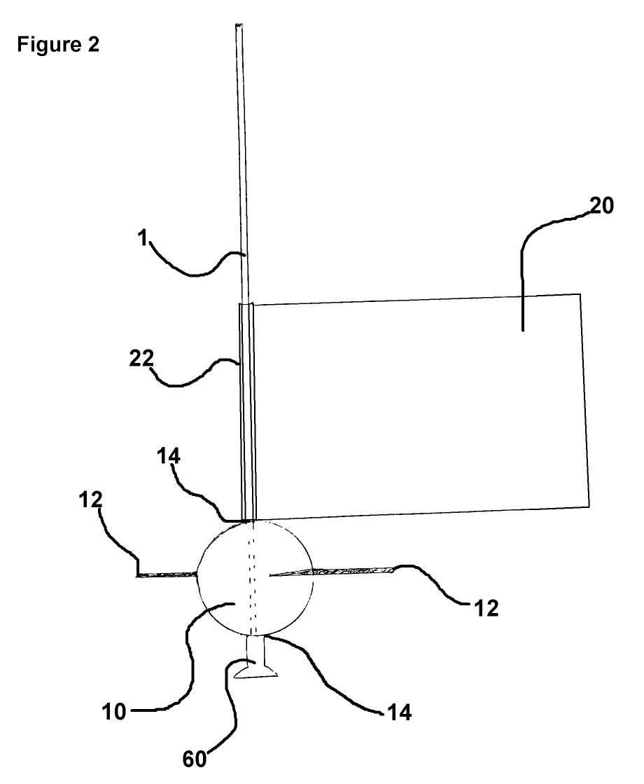

FIG. 2 displays the present invention under wind conditions of ten to thirty five mph. At this wind speed the fixed wings (12) create lift and cause rising member (10) to begin to rotate and rise along antenna (1). Indicia (20) rises with rising member (10) and waves fully extended, characteristics mirroring that of any flag or banner when exposed to wind speeds of ten to thirty five mph.

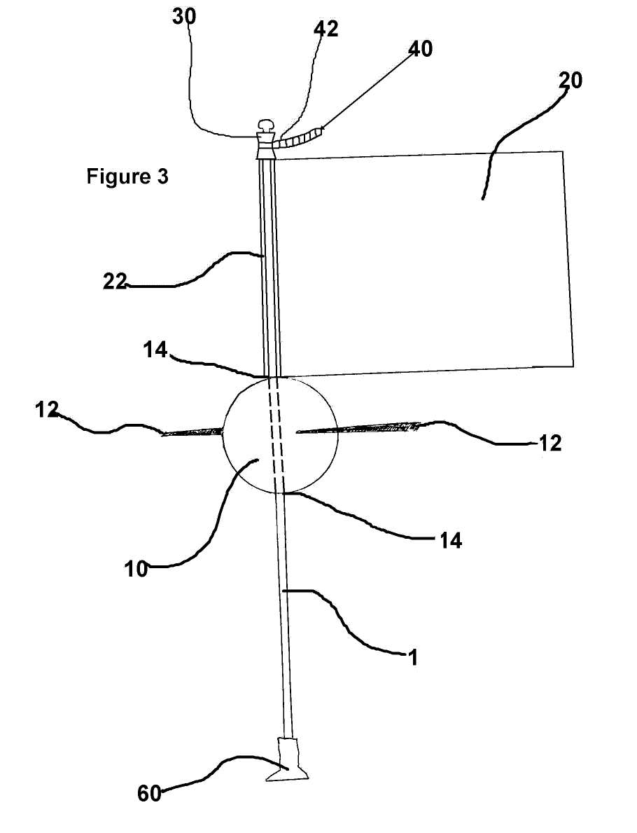

FIG. 3 displays the present invention at wind speeds over thirty five mph. The present invention is at the top of the antenna (1). Rising member (10) continues to spin and indicia (20) continues to wave. At the top of antenna (1) is a device, stopper (30) and tie wrap (40), designed to prevent the removal of the present invention. Stopper (30) is placed at the tip of antenna (1) above indicia (20) and is secured by tie wrap (40). Once tie wrap (40) is applied the excess material can be cut off at point 42. In an alternate embodiment rising member (10) does not rotate as it rises or falls. This is accomplished by widening the width of fixed wings (12) and level them out so as to be parallel to the ground such as the wings of an airplane.

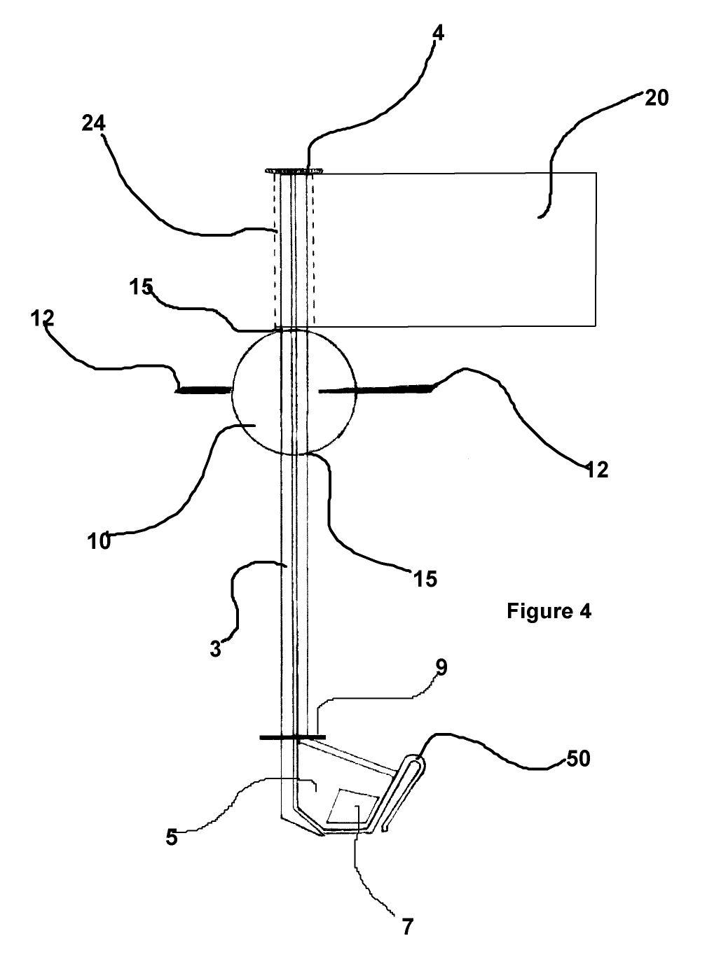

FIG. 4 displays the alternate embodiment in the event that the consumers' vehicle does not posses an antenna. The preferred alternate embodiment is constructed is completely of durable plastic. Fastening means 50 attaches to the vehicle's window and the window is rolled up completely to secure the present invention to the vehicle. Then arm (5) containing hole (7) for aerodynamic purposes, angles staff (3) enough away from the body of the vehicle so as to not interfere with either the present inventions or the vehicle's function in any way. At the base of staff (3) is a disk (9) that creates a flat surface for rising member (10) to rest on when in resting position. Staff (3) is a rod holding rising member (10) and indicia (20). Staff (3) looks as if two long, flat pieces of plastic were put together to form a plus sign if looked at from a top view displayed in FIG. 5. Rising member (10) and indicia (20) remain the same with the exception of large apertures (15) and large sleeve (24). Because of staff (3), which is significantly different from antenna (1), large apertures (15) and large sleeve (24) must be larger in size to accommodate staff (3). At the top of staff (3) is end cap (4). End cap (4) serves the same purpose as stopper (30) but is more permanent.

The present invention including the alternate embodiment maybe manufactured using materials such as plastic, Styrofoam, aluminum, or a light weight wood, to ensure that the present invention is fully functional and sturdy.

Having illustrated the present invention, it should be understood that various adjustments and versions might be implemented without venturing away from the essence of the present invention. The present invention is not limited to the embodiments described above, and should be interpreted as any and all embodiments within the scope of the following claims.

1. An animated device for a vehicle antenna, comprising:
a rising member having an aperture;
a smooth pole, disposed through said aperture of said rising member, said rising member rotating in complete rotations about said pole as said rising member rises; and
two fixed oppositely disposed wings, extending laterally outward from said rising member, wherein said fixed wings are planar and perpendicular to the plane of said pole.

2. The device of claim 1, wherein said rising member is lightweight.

3. The device of claim 1, wherein said rising member is a sphere.

4. The device of claim 3, wherein said sphere is lightweight.

5. The device in claim 1 further comprising a sleeve, in communication with said rising member.

6. The device in claim 5 further comprising an indicia, in communication with said sleeve.

7. The device of claim 5, wherein the circumference of said sleeve is larger than the antenna.

8-17. (canceled)

18. The device of claim 1, further comprising a sleeve, adjacent to, but not fixed to, said rising member.
